(19) United States
(12) Patent Application Publication
(10) Pub. No.: US 2005/0010324 A1
(43) Pub. Date: Jan. 13, 2005

(54) Device and method for monitoring collisions of a machine component with a workpiece or another machine component

(75) Inventors: Michael Kaever, Erlangen (DE); Robert Pulawski, Erlangen (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/870,692

(22) Filed: Jun. 17, 2004

(30) Foreign Application Priority Data
Jun. 18, 2003 (DE) 103 27 600.9

(51) Int. Cl. G06F 19/00

(52) U.S. Cl. 700/178

(57) ABSTRACT

A device and a method for monitoring collisions between a machine component and a workpiece or another machine component in a machine tool production machine are disclosed. At least one distance sensor is disposed on or in the immediate vicinity of the monitored machine component, whereby the distance sensor generates a distance signal when a tool or another machine component enters the sensor region. The distance signal is transmitted to a machine controller that computes a distance and initiates suitable countermeasures if the distance is outside a permissible range or is otherwise implausible. The device and method are therefore capable of preventatively and reliably detecting a potential collision or the lack of a collision between a machine component and a workpiece or another machine component and initiate appropriate countermeasures.

### CROSS-REFERENCES TO RELATED APPLICATIONS

This application claims the priority of German Patent Application, Serial No. 103 27 600.9, filed Jun. 18, 2003, pursuant to 35 U.S.C. 119(a)-(d), the disclosure of which is incorporated herein by reference.

### BACKGROUND OF THE INVENTION

The present invention relates to a device and a method for monitoring collisions between a machine component and a workpiece or another machine component in a machine tool or production machine.

It is essential to prevent collisions between a machine component of a machine tool or production machine and a workpiece or another machine component. Such collisions can cause substantial damage to the equipment due to the high velocities and the large masses. Accordingly, monitoring collisions provides substantial economic benefits.

Modern machines include collision monitoring systems that cooperate with a tool holder that provides process-related information, for example, in the form of force, vibration and temperature signals of the machining operation. A collision is recognized by comparing measured values with threshold values.

It is also known to recognize a collision by measuring motor currents of a drive system of the machine. A collision is here also recognized when the measured values exceed threshold values.

In addition, simple mechanical friction couplings are frequently used that disengage in the event of a collision due to an applied excessive force and/or torque, thereby separating the drive from the movable parts of the machine. The consequences of collisions are thereby limited to an uncontrolled decrease of the motion energy, while preventing the drive from applying additional forces.

All three of the afore-described methods recognize a collision only after the collision has already happened. Accordingly, these methods are not capable of preventatively recognizing and preventing a collision.

Two methods are known that can recognize a collision before the collision happens. For example, a collision test, for example in a CAM system (Computer Aided Manufacturing), can be used to evaluate the absence of collisions in a machining process. This is done, for example, after the motion path of a machine component or a tool have been generated. It is then determined by defining boundary conditions based on the parameters of the workpiece or tool geometry, the machine geometry and machine mechanism, and the motion path generated by the CAM system, if the generated motion path is collision-free.

Moreover, a protective space can also be monitored statically, wherein the monitoring function can integrated with the controller. By defining a protective space, static machine components can be protected from structures that are attached statically on the machine. The machine controller prevents movement into the space where collisions are possible.

Both methods for preventatively recognizing collisions, however, are based on static and more or less perfect assumptions about the geometry and the position of the different machine components and workpieces. Parameterizing such methods is not only complex, but deviations from the postulated conditions, for example due to operating or input errors, can also cause collisions. Examples of such errors are improperly clamped tools, clamping devices of the wrong type or installed at a different location, tool holder carrying the wrong tools, etc.

The afore-described conventional methods are therefore incapable of reliably preventing a collision and merely limit the damage caused by a collision.

It would therefore be desirable and advantageous to provide an improved device and method for monitoring collisions between a machine component and a workpiece or another machine component which obviates prior art shortcomings and is able to specifically detect such collisions before they actually occur and initiate suitable countermeasures.

### SUMMARY OF THE INVENTION

According to one aspect of the present invention, a device for monitoring collisions between a machine component and a workpiece or another machine component in a machine tool or production machine includes a distance sensor attached either to or in the immediate vicinity of the monitored machine component. The distance sensor defines a corresponding sensor region and generates a distance signal when a workpiece or the other machine component enters the corresponding sensor region. The device further includes a machine controller that receives the distance signal from the distance sensor and computes from the distance signal a distance. The machine controller prevents a collision between the machine component and the workpiece or the other machine component, if the distance is outside a permissible range or is implausible. Alternatively or in addition, the machine controller stops the production or manufacturing process if the workpiece or the other machine component is expected to enter the sensor region of the distance sensor, but the controller fails to detect a distance signal.

According to another aspect of the invention, a method for monitoring collisions between a machine component and a workpiece or another machine component in a machine tool or production machine includes the steps of attaching a distance sensor to or in the immediate vicinity of the monitored machine component, wherein the distance sensor defines a sensor region and generates a distance signal when the workpiece or the other machine component enters the sensor region of the distance sensor. The method further includes the steps of transmitting the distance signal to a machine controller, and processing the distance signal in the controller for preventing a collision between the machine component and the workpiece or the other machine component, if the distance is outside a permissible range or is implausible, or for stopping the production or manufacturing process if the workpiece or the other machine component is expected to enter the sensor region of the distance sensor, but the controller fails to detect a distance signal.

The present invention makes it possible to identify possible collisions before they actually happen. A collision can be prevented by a suitable reaction of the controller. By using sensors, the machine and its components can be monitored based not on idealized assumptions, but instead based on the actual situation in the machine. A collision can then be identified that could not be identified or measured with the conventional methods described above. As a result, the invention provides a reliable and practical collision monitoring method and device which offers protection through the use of sensors to eliminate the possibility of human error.

According to another feature of the present invention, the distance sensor can be an ultrasound sensor, a radar sensor, an electromagnetic sensor, an optical sensor, a magnetic sensor, and/or a mechanical sensor. Such sensors are frequently used as distance sensors in modern machines.

According to another feature of the present invention, the distance sensor can be attached to or in the immediate vicinity of the monitored machine component so as to monitor effectively a space around the tool that is currently used. In this way, the employed tool can be monitored directly.

According to another feature of the present invention, the distance sensor can be attached to or in the immediate vicinity of the monitored machine component so as to effectively monitor a space around a tool holder. In this way, collisions can be purposely monitored in the region around the tool holder.

According to another feature of the present invention, the distance signal can be a binary signal, because evaluating a binary signal is particularly simple with the employed controller.

According to another feature of the present invention, the controller can also include a memory for storing position parameters of the workpiece or the other machine component(s), whereby the controller compares a determined distance with the stored position parameters so as to prevent a collision between the machine component and the workpiece or the other machine component if the distance is outside a permissible range or implausible. Alternatively or in addition, the production or manufacturing process can be halted if the workpiece or the other machine component is expected to enter the sensor region of the distance sensor and a distance signal is not detected. By comparing the desired position parameters stored in the controller with the distance signal, an erroneously positioned machine component or workpiece can be quite easily identified.

Advantageously, the monitored machine component can be prevented from further approaching the workpiece or the other machine component if the distance signal indicates the monitored machine component is outside a permissible range or a plausible distance, thereby preventing the monitored machine component from colliding with the workpiece or with the other machine component. A collision can be reliably prevented by preventing a further approach of the monitored machine component.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a diagram of one embodiment of a sensor arrangement for monitoring collisions in accordance with the present invention;

FIG. 2 is a top view of the sensor arrangement of FIG. 1;

FIG. 3 shows a diagram of another embodiment of a sensor arrangement for monitoring collisions in accordance with the present invention;

FIG. 4 is a top view of the sensor arrangement of FIG. 3; and

FIG. 5 shows a block diagram of a device for monitoring collisions in accordance with the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

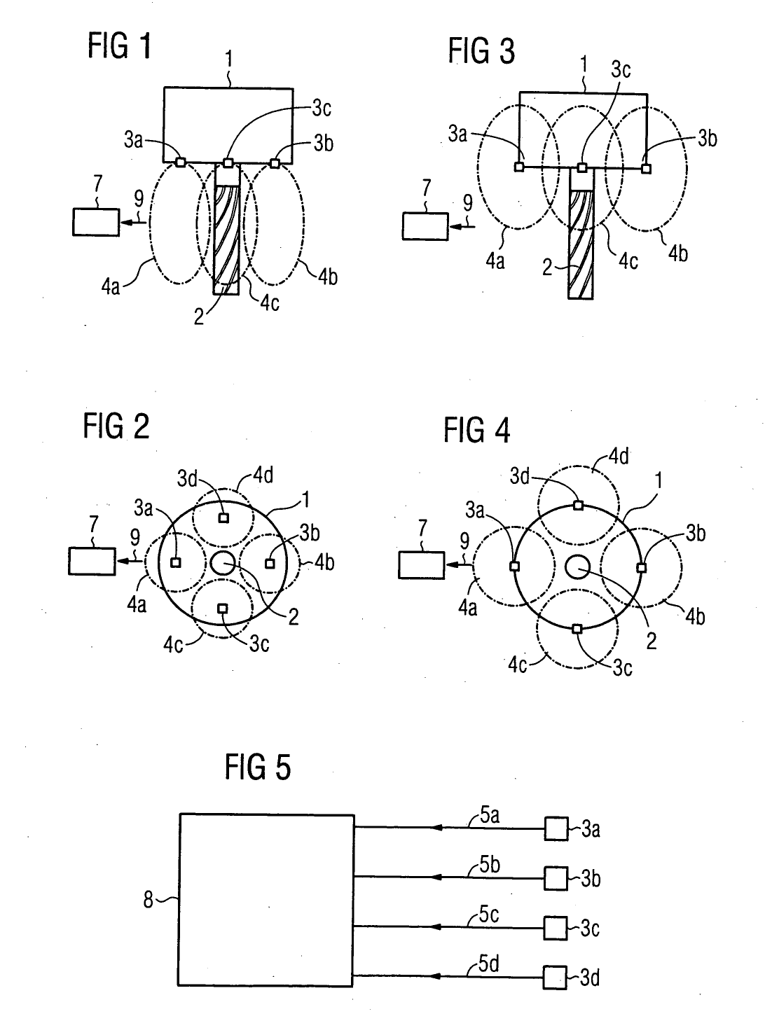

Turning now to the drawing, and in particular to FIGS. 1 and 2, there is shown schematically a first embodiment of the device for monitoring collisions according to the invention. FIG. 1 shows a tool holder 1 as well as a tool 2 clamped in the tool holder 1 for machining a workpiece 7. The tool holder 1 and the tool 2, which in the illustrated embodiment is implemented as a milling head, represent machine components of a machine tool or production machine; the machine tool or production machine itself is not shown for sake of clarity. Four distance sensors 3a, 3b, 3c and 3d are attached to the bottom of the tool holder 1, as shown in FIGS. 1 and 2. The distance sensor 3d is obscured from view in FIG. 1 and not shown. The distance sensors 3a, 3b, 3c and 3d depicted in FIGS. 1 and 2 are capable of measuring within the corresponding sensor region 4a, 4b, 4c and 4d the distance between a workpiece 7 and the corresponding distance sensor 3a, 3b, 3c and 3d, or when the workpiece 7 enters the corresponding sensor region. The distance sensors 3a, 3b, 3c and 3d are located in such way that the corresponding sensor regions 4a, 4b, 4c and 4d monitor essentially the region around the tool 2 to identify when an object enters a sensor region.

Referring now also to FIG. 5, the distance sensors 3a, 3b, 3c and 3d produce distance signals 5a, 5b, 5c and 5d that are transmitted to a machine controller 8 via corresponding connections. The sensor regions 4a, 4b, 4c and 4d covered by the distance sensors are monitored by the controller 8 to detect when objects, such as workpieces or machine components, enter one or more sensor regions 4a, 4b, 4c and 4d.

In the illustrated first exemplary embodiment, the machine controller 8 moves the tool holder 1 with the tool 2 towards the workpiece 7 in the direction of the arrow 9. When the workpiece 7 enters, for example, the sensor region 4a of the distance sensor 3a, the distance sensor 3a transmits a distance signal 5a to the controller 8. Likewise, distance signals are also transmitted by the other distance sensors if an object enters one of their sensor regions.

Depending on the employed sensor type and the position of the sensor on the monitored machine component, the distance from the workpiece 7 to the tool 2 or the tool holder 1 is measured and transmitted as a signal to the controller 8. Alternatively, in the simplest case, the controller 8 is notified only if the distance signal indicates that an object has entered the monitored space. In the latter case, the distance signal can be a binary signal.

The controller 8 depicted schematically in FIG. 5 processes the distance signal and prevents a collision between the monitored machine component 2 and the workpiece 7 or another machine component when the distance is outside a permissible range or not plausible. Alternatively, the production or manufacturing process is halted if a workpiece or another machine component enters the sensor region of the distance sensor and the controller fails to identify a distance signal. The controller 8 processes the distance signals 5a, 5b, 5c and 5d and compares the distance signals with desired position parameters of the machine components and the workpiece 7 stored in the controller 8 so as to prevent a collision between the monitored machine component and the workpiece 7 or another machine component. Alternatively, if a workpiece 7 or another machine component is expected to enter the sensor region of the distance sensors and the controller 8 does not recognize a distance signal, then the controller 8 can halt the production or manufacturing process.

It should be noted that this point, that the controller 8 can also be implemented as a regulator.

To prevent a collision, the controller 8 prevents the monitored machine component from coming closer to the workpiece 7 or another machine component if that distance is outside a permissible range or implausible.

Accordingly, the collision monitoring system and method operates in two directions. On one hand, undesirable collisions can be prevented by precluding a monitored machine component from coming closer to a workpiece or another machine component when the distance is outside a permissible range or implausible. On the other hand, the collision monitoring system and method can also check if a collision actually occurs when a collision is desired or expected, for example, when the tool 2 machines the workpiece 7. If such desired or expected collision does not occur, then the controller 8 halts the production or manufacturing process, since the machine components and/or the workpiece are obviously arranged outside a permissible or reasonable range.

It should be noted that the tool 2 clamped in the tool holder 1 can also be regarded as a machine component.

FIGS. 3 and 4 show another embodiment of a collision monitoring system according to the invention. In FIGS. 3 and 4 the same reference characters are used as in FIGS. 1 and 2. The embodiment of FIGS. 3 and 4 is identical to that depicted in FIGS. 1 and 2, respectively, except for a slightly different spatial arrangement of the distance sensors 3a, 3b, 3c, and 3d, which now essentially monitor the region around the tool holder 1 and only a small portion of the region of the tool 2.

Depending on the particular arrangement of the distance sensors, the number of the distance sensors and the sensor type, arbitrarily shaped and located sensor regions and/or protected regions can be defined and monitored.

It will be understood, that both embodiments can be combined, so that both the tool 2 and the tool holder 1 can be monitored simultaneously. This may require more sensors, and the arrangement and the type of the sensors may have to be adapted to the particular configuration of the protected regions.

Any machine component of the machine can be monitored for collisions by arranging one or more distance sensors on the monitored machine component. For example, with respect to a robot, specific segments of the robot arm can be monitored for collisions.

It will be understood that the number of distance sensors employed in the two embodiments can be increased, for example from four to eight. The additional distance sensors can be used to completely cover the gaps that are visible between the sensor regions 4a, 4b, 4c and 4d, for example in FIGS. 2 and 4, thereby further improving the collision protection.

Machine tools in the context of the present invention can also include, for example, uniaxial or multi-axis lathes, milling machines, as well as drilling or grinding machines. Machine tools can further include processing centers, linear and rotary transfer machines, laser machines, rolling machines and/or gear cutters. These machines have in common that the material is machined along several axes. Production machines in the context of the present invention can include textile, paper, plastic, wood, glass, ceramic or stone processing machines, as well as machines used for forming, packaging, printing, conveying, lifting, pumping, transporting. Furthermore, fans, blowers, wind turbines, lifting gear, cranes, robots, production and assembly lines are also included under the term production machines in the context of the present invention.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A device for monitoring collisions of a machine component with a workpiece or with another machine component in a machine tool or production machine, comprising:
at least one distance sensor attached to the monitored machine component or in an immediate vicinity of the monitored machine component, said at least one distance sensor defining a corresponding sensor region and generating a distance signal when a workpiece or the other machine component enters the corresponding sensor region; and
a machine controller receiving said distance signal from the at least one distance sensor and computing a distance from the distance signal so as to prevent a collision between the machine component and the workpiece or the other machine component, if the distance is outside a permissible range or is implausible, or to halt a production or manufacturing process if the workpiece or the other machine component is expected to enter the sensor region of the at least one distance sensor and the controller fails to detect a distance signal.

2. The device of claim 1, wherein the at least one distance sensor is a sensor selected from the group consisting of ultrasound sensor, radar sensor, electromagnetic sensor, optical sensor, magnetic sensor, and mechanical sensor.

3. The device of claim 1, wherein the at least one distance sensor is attached to the monitored machine component or in the immediate vicinity of the monitored machine component so as to monitor effectively a space around a tool that is currently used.

4. The device of claim 1, wherein the at least one distance sensor is attached to the monitored machine component or in the immediate vicinity of the monitored machine component so as to effectively monitor a space around a tool holder.

5. The device of claim 1, wherein the distance signal is a binary signal.

6. The device of claim 1, the controller further comprising a memory for storing position parameters of the workpiece or the other machine components, wherein the controller compares the distance with the stored position parameters so as to prevent a collision between the machine component and the workpiece or the other machine component or to stop the production or manufacturing process.

7. A method for monitoring collisions of a machine component with a workpiece or another machine component in a machine tool or production machine, comprising the steps of:
attaching at least one distance sensor to the monitored machine component or in the immediate vicinity of the monitored machine component, with the at least one distance sensor defining a sensor region and generating a distance signal when the workpiece or the other machine component enters the sensor region of the distance sensor,
transmitting the at least one distance signal to a machine controller, processing the at least one distance signal in the machine controller to compute a distance, and
preventing a collision between the machine component and the workpiece or the other machine component, if the computed distance is outside a permissible range or is implausible, or
halting a production or manufacturing process if the workpiece or the other machine component is expected to enter the sensor region of the at least one distance sensor and the machine controller fails to detect a distance signal.

8. The method of claim 7, further comprising the steps of:
storing a position parameter of the workpiece or the other machine components;
comparing the at least one distance signal with the stored position parameter; and
preventing a collision between the monitored machine component and the workpiece or the other machine component if the distance is outside a permissible range or is implausible, or
halting the production or manufacturing process if the workpiece or the other machine component is expected to enter the sensor region of the at least one distance sensor and no distance signal is detected.

9. The method of claim 7, further comprising the step of preventing the monitored machine component from further approaching the workpiece or the other machine component if the at least one distance signal indicates that the distance is outside a permissible range or is implausible.
